(19) United States
(12) Patent Application Publication
(10) Pub. No.: US 2025/0387950 A1
(43) Pub. Date: Dec. 25, 2025

(54) MIXER FOR POLYMER PROCESSING AND METHOD OF OPERATING A MIXER

(71) Applicant: HARBURG-FREUDENBERGER MASCHINENBAU GMBH, Hamburg (DE)

(72) Inventors: Markus Hesse, Freudenberg (DE); Pascal Wäschenbach, Niederfischbach (DE)

(21) Appl. No.: 18/879,991

(22) PCT Filed: Jul. 7, 2023
(86) PCT No.: PCT/EP2023/068873

§ 371 Date: Dec. 30, 2024

(30) Foreign Application Priority Data
Jul. 8, 2022 (DE) 10 2022 117 107.8

(51) Int. Cl. B29B 7/18; B01F 27/702; B01F 27/705; B01F 27/706; B01F 35/21; B01F 35/71; B01F 101/00; B29B 7/24; B29B 7/28; B29K 21/00

(52) U.S. Cl. CPC B29B 7/183; B01F 27/702; B01F 27/705; B01F 27/706; B01F 35/2115; B01F 35/7174; B29B 7/248; B29B 7/286; B01F 2101/2805; B29K 2021/00

(57) ABSTRACT

A mixer (1) for mixing a mixing material (13) in polymer processing comprises a mixing chamber (2) and more than two rotors (6a-6d) arranged in the mixing chamber (2). In particular, the rotors (6a-6d) can be configured to interlock.

### CROSS-REFERENCE TO RELATED APPLICATIONS

This patent application is a national phase filing under section 371 of PCT/EP2023/068873, filed Jul. 7, 2023, which claims the priority of German patent application no. 102022117107.8, filed Jul. 8, 2022, each of which is incorporated herein by reference in its entirety.

### TECHNICAL FIELD

The present invention relates to a mixer for mixing materials in polymer processing. In particular, the mixing material may be elastomers for the rubber processing industry. In addition to a polymer material, the mixing material may also comprise one or more additives. The mixer is configured in particular as an internal mixer with a mixing chamber into which the components of the mixing material are filled, a mixing process then takes place and the mixed mixing material is finally discharged through a discharge opening.

### BACKGROUND

The basics of rubber processing are described in the publication “Technologie der Kautschukverarbeitung” by Andreas Limper, Peter Barth and Franz Grajewski from 1989. Publication EP 3 746 278 B1 discloses an internal mixer for mixing material with interlocking rotors.

### SUMMARY

Embodiments provide a mixer for polymer processing with improved properties. In particular, the mixer can have an improved mixing performance.

According to a first embodiments, a mixer for mixing a mixing material in polymer processing is disclosed. The mixer comprises a mixing chamber in which more than two rotors are arranged for mixing the mixing material.

The mixing material comprises, for example, a main component and one or more additives. The main component may be a polymer material, in particular an elastomer, for the rubber processing industry. The additives may be one or more powdered additives and/or liquid components, such as an oil.

In particular, the mixer is an internal mixer for carrying out a discontinuous mixing process. One or more components are fed into the mixing chamber, the mixture is mixed by rotating the rotors and finally the mixture is discharged by opening a discharge opening. Subsequently, a further mixing process can be carried out. The addition of one or more components, in particular a polymer, can be carried out via a plunger that presses the components into the mixing chamber. This is also referred to as a plunger mixer. Further additives can be introduced directly into the chamber, for example via nozzles.

It can also be a tandem mixer with a first mixing chamber and a second mixing chamber. At least one of the mixing chambers comprises more than two rotors.

The rotors can be configured to interlock. In particular, the mixer is configured such that the direction of rotation of the interlocking rotors is different. Operation may only be possible if the direction of rotation of the interlocking rotors is different. For example, the circles of rotation of the rotors overlap, so that complete rotation of a rotor is only possible when the rotor that is engaged with this rotor is rotating. For example, all rotors are configured to interlock, so that a complete rotation of one rotor is only possible when all other rotors rotate. In this case, a rotor can be directly engaged with another rotor or indirectly engaged via one or more other rotors.

For example, each rotor is directly engaged with exactly two other rotors. It is also possible for each rotor to be directly engaged with more than two other rotors. The interlocking configuration of a rotor with more than one rotor increases the total engagement area in the mixing chamber. For example, the mixing material can pass through more than one engagement area with each rotor rotation, so that the mixing result is improved and/or the mixing process is accelerated due to the particularly effective mixing in the engagement area. Overall, compared to a mixing chamber in which only two rotors are arranged, the size of the total engagement area is larger for the same chamber volume.

At least one of the rotors can be arranged below another one of the rotors in the direction of gravity. This has the advantage that mixture components, for example powdery components, can accumulate on the lower rotor during filling and swirling is reduced by the presence of the upper rotor.

Exactly four rotors can be arranged in the mixing chamber. For example, the rotors interlock one after another. The rotors can be arranged at the corners of a square.

Alternatively, the rotors can also be configured tangentially, so that the rotation circles do not overlap and thus a complete rotation of one rotor is possible without rotation of another rotor. It is possible for all rotors to be configured tangential, so that none of the rotors is engaged with another rotor. It is also possible for some of the rotors to be configured tangentially to each other and thus neither directly nor indirectly interlocked and for some other rotors to be interlocked. For example, only pairs of rotors can be configured to engage with each other and the pairs can be configured tangentially to each other.

The rotors can surround an interior region in which one or more components of the mixer are arranged. The interior region is an area that is not in the engagement area of the rotors.

For example, a temperature sensor is arranged in the interior region. Due to the arrangement in the interior region, temperature measurement is possible without being influenced by the temperature of a housing wall of the mixing chamber, so that the temperature can be determined more accurately.

Alternatively or additionally, a dispensing device for introducing at least one component of the mixing material can be arranged in the interior region. For example, this is an injection nozzle for introducing a liquid additive, such as oil. By introducing the component into the interior region, the mixing of the component into the mixing material can be improved. In addition, the occurrence of a lubricating film on a wall of the mixing chamber can be reduced.

According to a further aspect, a method for operating the mixer described in the foregoing is disclosed. In the method, the mixing material is mixed by simultaneous operation of the more than two rotors. One or more components of the mixing material can thereby be introduced into the mixing chamber by means of a plunger. In addition, one or more components can be introduced directly into an interior region surrounded by the rotors. This is, for example, a liquid additive such as oil.

The rotors can be configured interlocking, whereby the direction of rotation of the interlocking rotors is different.

The direction of rotation of the rotors can be such that the rotors which are to a charging through which a main component of the mixture is introduced, convey the mixing material directly into an engagement area of these rotors after entering the mixing chamber. It is also possible to select an opposite direction of rotation.

In the process, a filler, in particular a powdered filler, can be introduced into the mixing chamber. The filler can then accumulate by gravity in a lower region of the mixing chamber. In particular, the filler can accumulate in the area of one or more rotors that are arranged below one or more other rotors in the direction of gravity. Only then is a plunger lowered into the charging chamber to introduce a further component of the mixing material. In this way, stamp-induced swirling of the filler can be reduced.

The present invention comprises several aspects, in particular devices and methods. The features, properties and embodiments described for one of the aspects should also apply accordingly to the other aspect.

### BRIEF DESCRIPTION OF THE DRAWINGS

Furthermore, the description of the objects specified here is not limited to the specific embodiments. Rather, the features of the individual embodiments can be combined with one another, where this makes technical sense.

In the following, the objects described here are explained in more detail using schematic examples.

It shows:

FIG. 1 in a cross-section a mixer according to one embodiment,

FIG. 2 in an enlarged cross-section the mixing chamber of the mixer shown in FIG. 1,

FIG. 3 in a cross-section another embodiment of a mixing chamber, FIG. 4 in a cross-section a mixer according to a further embodiment,

FIG. 5 in a cross-section a representation of the accumulation of a component of the mixing material in a mixing chamber,

FIG. 6 in a cross-section a further embodiment of a mixing chamber,

FIG. 7 in a cross-section a further embodiment of a mixing chamber,

FIG. 8 in a schematic view process steps of a mixing process.

Preferably, in the following figures, the same reference signs refer to functionally or structurally corresponding parts of the various embodiments.

### DETAILED DESCRIPTION OF ILLUSTRATIVE EMBODIMENTS

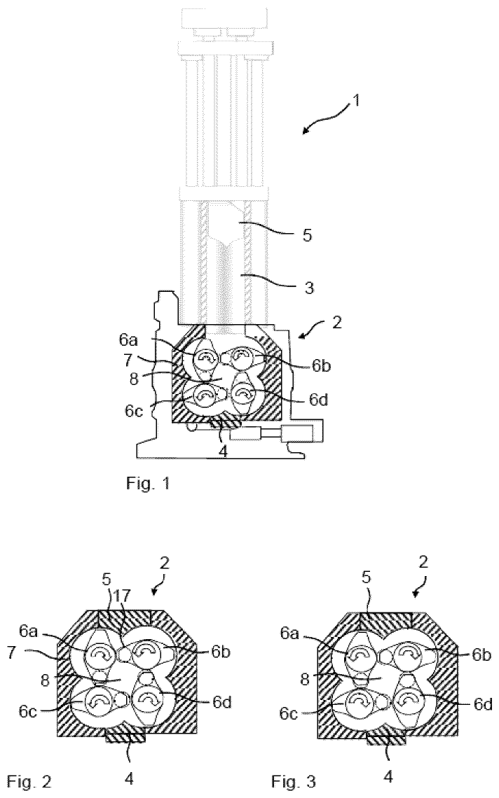

FIG. 1 shows an embodiment of a mixer 1 comprising a mixing chamber 2. The mixing chamber 2 can be filled from the top via a feeder 3 and discharged downwards via a discharge flap 4. The mixing material is, for example, one or more polymers, particularly a raw rubber mixture. Charging takes place with a plunger 5, which conveys the mixing material into the mixing chamber 2.

In particular, the mixer 1 is a so-called internal mixer, which is configured to carry out a discontinuous mixing process. The mixing material is hereby introduced into the mixing chamber 2, a mixing process is carried out and the mixing chamber 2 is emptied after mixing.

More than two rotors 6a, 6b, 6c, 6d are arranged in the mixing chamber 2. The rotors 6a-6d each have, for example, a rotor base and one or more rotor blades. The rotors 6a-6d are configured to interlock. Thus, the circles of rotation of the rotors 6a-6d overlap, so that none of the rotors 6a-6d can perform a complete rotation without at least one other of the rotors 6a-6d also rotating. In particular, interlocking rotors 6a-6d can also not rotate at different speeds. The interlocking of the rotors 6a-6d can be configured analogously to the interlocking of gears. The engagement areas 17 of the rotors 6a-6d, i.e. the areas in which the rotational circles overlap, are indicated here by circles. In the embodiment shown here, a complete rotation of one of the rotors 6a-6d is only possible with rotation of all rotors 6a-6d. Each of the rotors 6a-6d is in direct engagement with two other rotors 6a-6d.

The rotors 6a-6d are arranged at the corners of a square. Depending on the design of the rotors 6a-6d, a different arrangement is also possible. More than four rotors 6a-6d can also be arranged in the mixing chamber. In particular, the number of rotors should be even for interlocking rotors in which two rotors are engaged with each other.

The dispersive and/or distributive mixing performance of the mixer 1 can be increased by the interlocking design of the rotors 6a-6d. This is due to the fact that the mixing performance is particularly high in the engagement area of interlocking rotors 6a-6d. By the more than two interlocking rotors 6a-6d, the number of times the mixing material passes through the engagement area per rotor revolution is increased. In particular, the number can double. In addition, with four rotors 6a-6d, the volume of mixed material is divided between four engagement areas, which means that the probability of one pass is four times higher.

A mixer 1 of this type can achieve the volumetric advantages of a large mixer with the qualitative advantages of a small mixer. The qualitative advantages of a small mixer lie, among other things, in the smaller gap size between the rotors in the engagement area and between the rotors and the mixing chamber wall. In the concept, the overall engagement area is increased. Thus, a high mixing quality can be achieved with a lower number of rollovers, i.e. with fewer complete rotations of the rotors 6a-6d. In this way, the mixing time can be shortened and thus the throughput can be increased while maintaining the same quality of the mixing material, compared to mixers with only two rotors. Alternatively, a higher quality of mixing material can be achieved with the same mixing time and throughput.

In addition, the mixing material can be better tempered. For example, cooling channels are formed in a wall 7 of the mixing chamber 2 and/or in the rotors 6a-6d, through which a cooling liquid flows. If more than two rotors are provided, the ratio of temperature control surface area to mixing chamber volume is more favorable, as more temperature-controlled surface area is available. For example, the ratio of temperature control surface to mixing chamber volume, based on a mixing chamber volume of, for example, approx. 250 l, is approx. 21% higher in the embodiment shown here than in a mixer with only two rotors, which corresponds to the state of the art.

With the same mixing chamber volume, the distance between the rotor base and the wall 7 of the mixing chamber 2 is also smaller than in a mixing chamber with only two interlocking rotors. This means that the temperature of the mixing material can be changed more quickly. This is particularly important for mixing materials such as rubber, which is a poor heat conductor. This means that a lower temperature can be set during the mixing process. Due to the higher viscosity and the resulting higher shear and elongation stress, a better mixing quality can thus be achieved. Alternatively, the mixer 1 can be operated at higher speeds so that an increase in throughput can be achieved at the same temperature.

This can improve temperature control and monitoring of the mixing material during mixing. In particular, mixing can be carried out at a lower temperature compared to conventional mixers, thus improving the mixing quality. Alternatively, mixing can be carried out at a higher speed at the same temperature, thereby increasing the throughput.

Another advantage of having more than two interlocking rotors 6a-6d is that oils and other liquid components can be incorporated more effectively into the mixing material. The forced displacement of the mixing material in the engagement area of the rotors 6a-6d accelerates the incorporation of an oil into a rubber matrix. In the embodiment shown, there are four such engagement areas, so that a good mixing quality can be achieved with fewer rollovers of the rotors 6a-6d. For example, the mixing time can be shortened and the throughput increased while maintaining the same quality. Alternatively, the mixing quality can be improved compared to conventional mixers while maintaining the same mixing time and throughput.

In further embodiments, it is also possible for one or more rotors to be configured tangentially to one another, so that one or more rotors can also perform a complete rotation independently of one or more other rotors. For example, only the two upper rotors 6a, 6b and only the two lower rotors 6c, 6d can be interlocking, so that the rotational circles of the upper rotors 6a, 6b do not overlap with the rotational circles of the lower rotors 6c, 6d and the upper rotors 6a, 6b can be rotated independently of the lower rotors 6c, 6d. All rotors can also be configured tangentially to each other.

In a further embodiment, it is also possible for one or more rotors to be directly engaged with more than two rotors.

During mixing, the rotors 6a-6d can be operated with a direction of rotation as shown in FIGS. 1 and 2. In this case, the direction of rotation of the two upper rotors 6a, 6b, i.e. the rotors 6a, 6b closest to the feeder 3, is such that mixing material introduced from above is conveyed into an interior region 8 between the four rotors 6a-6d. In this way, a particularly good feed behavior of the mixer 1 can be achieved.

FIG. 3 shows an embodiment in which the direction of rotation of the rotors 6a-6d is opposite to the direction of rotation shown in FIG. 2.

In particular, the upper rotors 6a, 6b have a direction of rotation by which the mixing material is first conveyed outwards. By the interaction of the upper rotors 6a, 6b with the respective lower rotor 6c, 6d located below, the mixing material is then conveyed into the interior region 8. Due to the shown direction of rotation of the lower rotors 6c, 6d, the mixing material is conveyed through the engagement area of these rotors 6c, 6d directly towards the discharge flap 4, so that the discharge behaviour of the mixer 1 can be optimized.

It is also possible to change the direction of rotation during operation in order to achieve optimized feed behaviour at the start of the mixing process and optimized discharge behaviour at the end of the mixing process. For example, the direction of rotation shown in FIG. 2 is available first and then the direction of rotation shown in FIG. 3.

FIG. 4 shows another embodiment of a mixer 1, in particular a so-called tandem mixer.

The mixer 1 has a first mixing chamber 9 and a second mixing chamber 10. The first mixing chamber is an upper mixing chamber and the second mixing chamber is a lower mixing chamber. Otherwise, the structure is analogous to the mixer shown in FIG. 1. The mixing material is conveyed by a plunger 5 via the feeder 3 into the upper mixing chamber 9, where it undergoes a first mixing process. The mixing material then passes through a first discharge flap 11 of the first mixing chamber 9 into the second mixing chamber 10, where it is subjected to a second mixing process. The mixing material then falls downwards out of the mixer 1 by opening a second discharge flap 12.

Four interlocking rotors are arranged in each of the two mixing chambers 9, 10, as described for the embodiments of FIGS. 1 to 3. It is also possible that only the upper mixing chamber 9 or only the lower mixing chamber 10 has more than two rotors. It is also possible that one of the mixing chambers 9, 10 has a larger number of rotors than the other of the mixing chambers 9, 10. Specific embodiments of the mixing chambers as described with respect to FIGS. 1 and 2 can also be combined with each other.

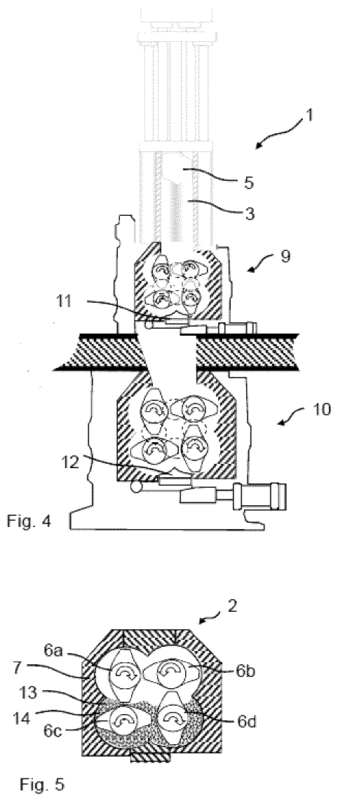

FIG. 5 shows an embodiment of a mixing chamber 2 according to the embodiments described above, wherein a component of the mixing material 13 in the form of a powdery filler 14 is shown in the mixing chamber 2.

Before the actual mixing process, a polymer, in particular a rubber material, and the powdered filler 14 are added to the mixing chamber 2 by the feeder 3. For example, the filler 14 is added to the feeder 3 through laterally mounted chutes. Once dosing is complete, the plunger 5 lowers and presses the mixture components into the mixing chamber 2. During the movement, the plunger 5 displaces air in the manner of an air pump. This can lead to whirling up of powdery mixture components, which are then often unintentionally extracted by an aspiration system. The extracted filter dust often has an undefined composition and is difficult to recycle without compromising on quality, meaning that the only option is to dispose of it at a charge.

In the embodiment shown, the powdered filler 14 can now fall gravimetrically into the lower half of the mixing chamber 2, in which the lower rotors 6c, 6d are arranged. Due to the upper rotors 6a, 6b arranged above, the filler 14 is shielded from the stamp-induced air turbulence, so that less material is lost due to aspiration. As a result, the material quality can be increased through better control of the filler quantity and thus a more precise composition according to the recipe. In addition, a reduction in material costs and environmentally friendly operation are made possible by less material disposal. Furthermore, less cleaning work needs to be carried out, which means that mixing cycles can be shortened. In particular, there is no need to clean the plunger 5 during mixing.

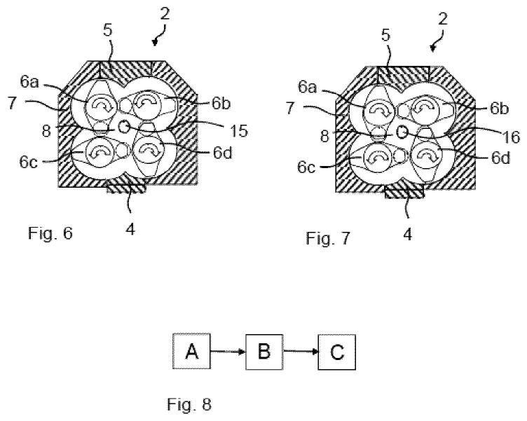

FIG. 6 shows a further embodiment of a mixing chamber 2 for the mixer 1 as described above. In addition to the features described in the preceding figures, a temperature sensor 15 for measuring the temperature of the mixing material is arranged in an interior region 8 surrounded by the rotors 6a-6d.

The interior region 8 is not touched by any of the rotors 6a, 6d, so that this area is well suited for the arrangement of further components. For example, the interior region 8 is located in the center of the arrangement of the rotors 6a-6d.

Compared to an arrangement of the temperature sensor 15 in a region of the wall 7 of the mixing chamber 2, the temperature sensor 15 in the embodiment shown here is placed deeper in the mixing chamber 2. This enables a more accurate temperature measurement and disturbing edge influences, such as temperature control of the mixing chamber 2, have less of an effect.

FIG. 7 shows a further embodiment of a mixing chamber 2 for the mixer 1 as described above. A dispensing device 16 for introducing one or more components of the mixture is provided in the interior region 8.

For example, the dispensing device 16 is an injector, in particular an injection valve, for liquid mixing components. These can be oil or other liquid components.

The delivery thus takes place away from the wall 7 of the mixing chamber 2, so that the formation of lubricating films on the inside of the wall 7 can be reduced. Usually, such components are injected through a lateral area of the wall 7 of the mixing chamber 2, so that lubricating films are easily formed there, which leads to a reduced power input of the mixer 1 and an extended mixing time. By dispensing directly into the interior region 8, the mixing time can be shortened and the throughput of the machine increased due to the lower tendency to form a lubricating film.

The dispensing device 16 may be present in addition to or as an alternative to the temperature sensor 15 of FIG. 6. For example, the dispensing device 16 and the temperature sensor 15 are arranged next to each other. For example, the dispensing device 16 and/or the temperature sensor 15 are arranged along an axis that runs parallel to the axis of rotation of the rotors 6a-6d.

FIG. 8 shows a method for mixing a mixing material with a mixer 1 as described in the foregoing.

In the process, the mixing chamber 2 is filled with components of the mixing material. In a first step A, a powdery material can be added to the mixing chamber 2.

After a waiting period during which the powdered material settles in the mixing chamber 2, as shown in FIG. 5 for example, a main component, such as a polymer, is added. The addition can take place in a step B via a plunger, which presses the material into the mixing chamber 2.

In a further step C, a liquid mixing component, such as oil, is added to an interior region 8 between the rotors 6a-6d. For example, step C takes place before and/or during mixing of the mixing material. It is possible that only one of steps A and C or both of these steps are carried out.

After mixing, the mixing material is removed from the mixing chamber 2, for example by opening a discharge flap 4.

1. A mixer (1) for mixing a mixing material (13) in polymer processing, comprising a mixing chamber (2) and more than two rotors (6a-6d) arranged in the mixing chamber (2).

2. The mixer (1) according to claim 1,
whereby the rotors (6a-6d) are configured to interlock.

3. The mixer (1) according to claim 2,
wherein each rotor (6a-6d) is in direct engagement with two or more than two other ones of the rotors (6a-6d).

4. The mixer (1) according to any of claims 1 to 3,
configured such that the direction of rotation of the interlocking rotors (6a-6d) is different.

5. The mixer (1) according to claim 1,
in which the rotors (6a-6d) are configured tangentially.

6. The mixer (1) according to any of the preceding claims, which comprises four or more than four rotors (6a-6d).

7. The mixer (1) according to any of the preceding claims, wherein at least one of the rotors (6a-6d) is arranged below another one of the rotors (6a-6d) in the direction of gravity.

8. The mixer (1) according to any of the preceding claims, comprising exactly four rotors (6a-6d) arranged at four corners of a rectangle.

9. The mixer (1) according to any of the preceding claims,
in which the rotors (6a-6d) surround an interior region (8), wherein at least one temperature sensor (15) is arranged in the interior region (8).

10. The mixer (1) according to any of the preceding claims,
in which the rotors (6a-6d) surround an interior region (8), wherein at least one dispensing device (16) for introducing at least one component of the mixing material (13) is arranged in the interior region (8).

11. The mixer (1) according to any of the preceding claims, comprising a plunger (5) for introducing one or more components of the mixing material (13) into the mixing chamber (2) and a discharge flap (4) for emptying the mixing chamber (2).

12. The mixer (1) according to any of the preceding claims, comprising a first mixing chamber (9) and a second mixing chamber (10), wherein more than two rotors (6a-6d) are arranged in at least one of the mixing chambers (9, 10).

13. A method for operating a mixer (1) according to any of the preceding claims, wherein the mixing material (13) is mixed in the mixing chamber by simultaneous operation of the more than two rotors (6a-6d).

14. The method according to claim 13, wherein the rotors (6a-6d) are configured to interlock, wherein the direction of rotation of the interlocking rotors (6a-6d) is different.

15. The method according to any of claim 13 or 14,
wherein at least one component of the mixing material (13) is introduced into an interior region (8) which is surrounded by the rotors (6a-6d).

16. The method according to any of claims 13 to 15,
wherein a direction of rotation of the rotors (6a-6d) closest to a charging (3) through which a main component of the mixing material (13) is introduced into the mixing chamber (2) is such that the mixing material (13) is conveyed into an engagement area of these rotors (6a-6d) after entering the mixing chamber (2).

17. The method according to any of claims 13 to 16,
wherein a direction of rotation of the rotors (6a-6d) closest to a charging (3) through which a main component of the mixing material (13) is introduced into the mixing chamber (2) is such that the mixing material (13) is conveyed away from an engagement area of these rotors (6a-6d) after entering the mixing chamber (2).

18. The method according to any of claims 13 to 17,
wherein prior to the mixing process at least one filler (14) is introduced into the mixing chamber (2) in such a way that the filler (14) can accumulate in a region of one or more of the rotors (6a-6d) which are arranged in the gravitational direction below one or more other ones of the rotors (6a-6d), and thereafter a plunger (5) is lowered in a feeder (3).
